(19) United States
(12) Patent Application Publication
(10) Pub. No.: US 2008/0180623 A1
(43) Pub. Date: Jul. 31, 2008

(54) LIQUID CRYSTAL DISPLAY DEVICE

(75) Inventors: Hyeok-Jin Lee, Seongnam-si (KR); Hee-Seop Kim, Hwaseong-si (KR); Jun-Woo Lee, Anyang-si (KR); LuJian Gang, Suwon-si (KR); Hwa-Sung Woo, Suwon-si (KR)

Correspondence Address: F. CHAU & ASSOCIATES, LLC, 130 WOODBURY ROAD, WOODBURY, NY, 11797, US

(73) Assignee: Samsung Electronics Co., Ltd., Suwon-si (KR)

(21) Appl. No.: 12/021,055

(22) Filed: Jan. 28, 2008

(30) Foreign Application Priority Data
Jan. 30, 2007 (KR) 10-2007-0009165

(51) Int. Cl. G02F 1/1343

(52) U.S. Cl. 349/139

(57) ABSTRACT

A liquid crystal display (LCD) device includes a lower substrate including a gate line, a data line, and a thin film transistor, a pixel electrode formed on the lower substrate and including a plurality of first rod-shaped electrodes spaced apart from one another at substantially regular intervals, an upper substrate disposed opposite the lower substrate, a common electrode formed on the upper substrate and including a plurality of second rod-shaped electrodes arranged alternately with the first rod-shaped electrodes at substantially same intervals as the first rod-shaped electrodes, and a liquid crystal disposed between the lower substrate and the upper substrate, wherein a width of each of the first and second rod-shaped electrodes is about 4 μm to about 6 μm and the arrangement interval thereof is about 11.5 μm to about 13.5 μm.

### CROSS-REFERENCE TO RELATED APPLICATION

This application claims priority to Korean Patent Application No. 10-2007-0009165, filed on Jan. 30, 2007, the contents of which are herein incorporated by reference in their entirety.

### BACKGROUND OF THE INVENTION

1. Technical Field

The present disclosure relates to a dual fringe field switching (DFS) mode liquid crystal display (LCD) device, and more particularly, to a DFS mode LCD device that minimizes decreases in brightness.

2. Discussion of the Related Art

A liquid crystal display (LCD) device displays an image by varying light transmittance through liquid crystal having an electro-optical anisotropy disposed between two electrodes receiving different voltages. The liquid crystal is driven by an electric field generated by the two electrodes.

LCD devices of various modes have improved side visibility and light transmittance. The various modes of the LCD devices are determined by, for example, a pattern of pixel and common electrodes generating electric fields, and/or an alignment direction of the liquid crystal.

In a dual fringe field switching (DFS) mode, a pixel electrode and a common electrode are formed on a lower substrate and an upper substrate, respectively, and the pixel electrode and the common electrode are patterned in predetermined shapes. For example, each of the pixel and common electrodes includes a plurality of rod-shaped electrodes arranged in parallel. The rod-shaped electrodes of the pixel electrode are arranged alternately with the rod-shaped electrodes of the common electrode. Accordingly, two fringe fields are generated by the alternately arranged pixel and common electrodes. In the DFS mode, a rubbing process is performed on the upper and lower substrates, and the liquid crystal is aligned horizontally with respect to the electric fields.

In the DFS mode LCD device, since the widths of the pixel and common electrodes are relatively small, a misalignment may occur when bonding the upper and lower substrates. The misalignment causes a reduced brightness in the DFS mode LCD device.

### SUMMARY OF THE INVENTION

Embodiments of the present invention provide a dual fringe field switching (DFS) mode liquid crystal display (LCD) device that can minimize decreases in brightness caused by, for example, a misalignment occurring when bonding an upper substrate and a lower substrate.

According to an exemplary embodiment of the present invention, a liquid crystal display (LCD) device comprises a lower substrate including a gate line, a data line, and a thin film transistor, a pixel electrode formed on the lower substrate and including a plurality of first rod-shaped electrodes spaced apart from one another at substantially regular intervals, an upper substrate disposed opposite the lower substrate, a common electrode formed on the upper substrate and including a plurality of second rod-shaped electrodes arranged alternately with the first rod-shaped electrodes at substantially same intervals as the first rod-shaped electrodes, and a liquid crystal disposed between the lower substrate and the upper substrate, wherein a width of each of the first and second rod-shaped electrodes is about 4 μm to about 6 μm and the arrangement interval thereof is about 11.5 μm to about 13.5 μm.

According to an exemplary embodiment of the present invention, a liquid crystal display (LCD) device comprises a lower substrate including a gate line, a data line, and a thin film transistor, a pixel electrode formed on the lower substrate, the pixel electrode including a plurality of first rod-shaped electrodes spaced apart from one another at substantially regular intervals and a first connection portion connecting end terminals of the plurality of first rod-shaped electrodes with one another, an upper substrate disposed opposite the lower substrate, a common electrode formed on the upper substrate, the common electrode including a plurality of second rod-shaped electrodes arranged alternately with the first rod-shaped electrodes and a second connection portion connecting end terminals of the plurality of second rod-shaped electrodes with one another, a liquid crystal disposed between the lower substrate and the upper substrate, and a texture prevention portion formed at a first area where a first rod-shaped electrode is connected to the first connection portion or a second area where a second rod-shaped electrode is connected to the second connection portion, wherein the texture prevention portion is inclined with respect to the first rod-shaped electrode or the second rod-shaped electrode.

The texture prevention portion may form an angle of about 20° to about 60° with respect to the first rod-shaped electrode or the second rod-shaped electrode.

The texture prevention portion may form an angle of about 30° with respect to the first rod-shaped electrode or the second rod-shaped electrode.

The texture prevention portion can be formed at two edges facing each other, respectively, in a rectangle defined by the first rod-shaped electrode and the first connection portion or defined by the second rod-shaped electrode and the second connection portion.

The first connection portion may connect one end of the first rod-shaped electrodes with each other formed in a direction, and the second connection portion may connect one end of the second rod-shaped electrodes with each other formed in the opposite direction to that of the first rod-shaped electrodes.

The first connection portion may connect one end of the first rod-shaped electrodes with each other formed in a direction, and the second connection portion may connect one end of the second rod-shaped electrodes with each other formed in the same direction as that of the first rod-shaped electrodes.

According to an exemplary embodiment of the present invention, a liquid crystal display (LCD) device comprises a lower substrate including a gate line, a data line, and a thin film transistor, a pixel electrode formed on the lower substrate, the pixel electrode including a plurality of first rod-shaped electrodes spaced apart from one another at substantially regular intervals and a first connection portion connecting one end of the plurality of first rod-shaped electrodes with one another, an upper substrate disposed opposite the lower substrate, a common electrode formed on the upper substrate and including a plurality of second rod-shaped electrodes arranged alternately with the first rod-shaped electrodes and a second connection portion connecting one end of the plurality of second rod-shaped electrodes with each other, and a liquid crystal disposed between the lower substrate and the upper substrate.

The first connection portion may connect one end of the first rod-shaped electrodes with each other formed in a direction, and the second connection portion may connect one end of the second rod-shaped electrodes with each other formed in the opposite direction to that of the first rod-shaped electrodes.

The first connection portion may connect one end of the first rod-shaped electrodes with each other formed in a direction, and the second connection portion may connect one end of the second rod-shaped electrodes with each other formed in the same direction as that of the first rod-shaped electrodes.

### BRIEF DESCRIPTION OF THE DRAWINGS

Exemplary embodiments of the present invention can be understood in more detail from the following descriptions taken in conjunction with the accompanying drawings, in which:

FIG. 1 is a plan view showing a liquid crystal display (LCD) device in accordance with an exemplary embodiment of the present invention;

FIG. 2 is a cross-sectional view taken along the line I-I′ of FIG. 1;

FIG. 3 is a schematic diagram showing fringe fields in accordance with an exemplary embodiment of the present invention;

FIG. 4 is a plan view showing a texture prevention portion in accordance with an exemplary embodiment of the present invention;

FIG. 5 is a plan view showing a structure of a pixel electrode and a common electrode in accordance with an exemplary embodiment of the present invention;

FIGS. 6A and 6B are a plan view and a cross-sectional view, respectively, illustrating a method of manufacturing an LCD device using a first mask process in accordance with an exemplary embodiment of the present invention;

FIGS. 7A and 7B are a plan view and a cross-sectional view, respectively, illustrating a method opf manufacturing an LCD device using a second mask process in accordance with an exemplary embodiment of the present invention;

FIGS. 8A and 8B are a plan view and a cross-sectional view, respectively, illustrating a method of manufacturing an LCD device using third and fourth mask processes in accordance with an exemplary embodiment of the present invention;

FIGS. 9A and 9B are a plan view and a cross-sectional view, respectively, illustrating a method of manufacturing an LCD device using a fifth mask process in accordance with an exemplary embodiment of the present invention; and

FIG. 10 is a plan view showing a shape of a common electrode in an LCD device in accordance with an exemplary embodiment of the present invention.

### DETAILED DESCRIPTION OF EXEMPLARY EMBODIMENTS

The invention is described more fully hereinafter with reference to the accompanying drawings, in which embodiments of the invention are shown. This invention may, however, be embodied in many different forms and should not be construed as limited to the embodiments set for the herein.

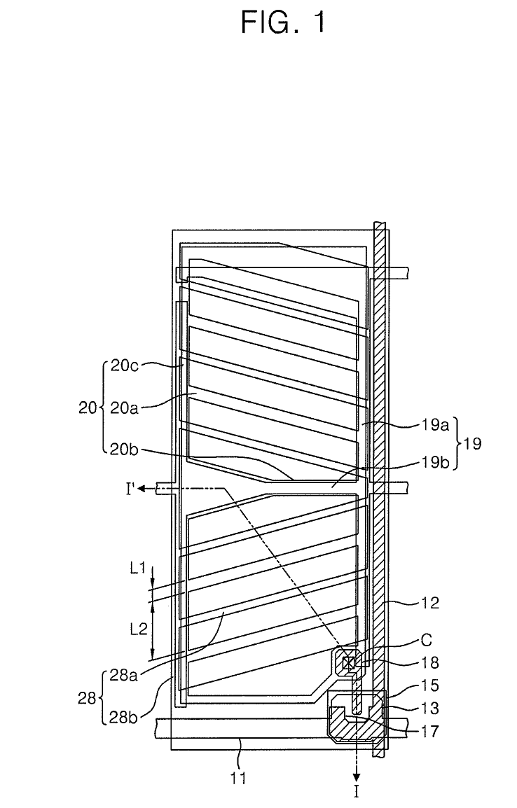

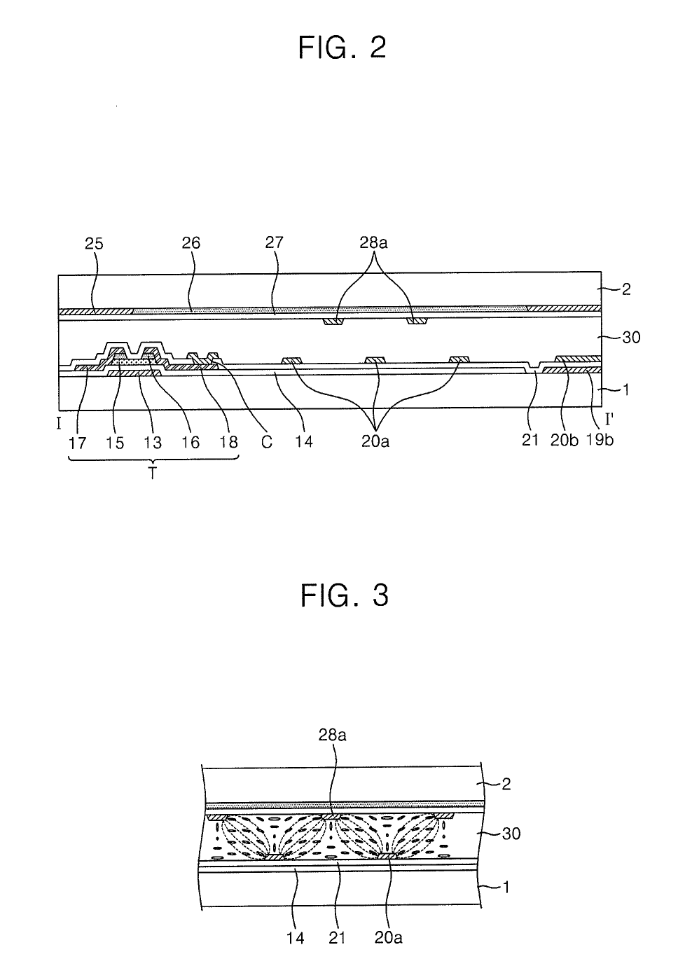

A liquid crystal display (LCD) device in accordance with an exemplary embodiment of the present invention is described with reference to FIGS. 1 and 2. FIG. 1 is a plan view showing an LCD device in accordance with an exemplary embodiment of the present invention. FIG. 2 is a cross-sectional view taken along the line I-I′ of FIG. 1.

The LCD device in accordance with an exemplary embodiment of the present invention is a dual fringe field switching (DFS) mode LCD device. Referring to FIGS. 1 and 2, the DFS mode LCD includes a lower substrate 1, an upper substrate 2, a pixel electrode 20, a common electrode 28, a gate line 11, a data line 12, a thin film transistor T, a storage pattern 19, and liquid crystal 30.

The lower substrate 1 includes a plurality of pixel areas arranged in a matrix. The thin film transistor T, which is a switching element, is included in each pixel area. A signal line for transmitting signals to the thin film transistor T is formed on the lower substrate 1. The pixel electrode 20 connected to the thin film transistor T and applied with a pixel signal is arranged in each pixel area.

The gate line 11 supplies a scan signal to the thin film transistor T. Referring to FIG. 1, the gate line 11 is formed in a line shape on the lower substrate 1. The gate line 11 may comprise a conductive metal in a single layer or in a multi-layer structure. The gate line 11 is connected to a gate electrode 13 of the thin film transistor T.

The data line 12 intersects the gate line 11, for example, as shown in FIG. 1. A pixel signal is applied to the data line 12. The pixel signal applied to the data line 12 is transmitted to the pixel electrode 20 and charged thereto while a channel of the thin film transistor T is opened by a scan signal applied to the gate line 11.

The data line 12 may comprise a conductive metal in a single layer or in a multi-layer structure.

Referring to FIG. 2, the thin film transistor T includes a gate electrode 13, a semiconductor layer 15, an ohmic contact layer 16, and source and drain electrodes 17 and 18. The gate electrode 13 contacts the gate line 11 and arranged on the upper surface of the lower substrate 1. The gate electrode 13 may be positioned in the upper portion of the thin film transistor T.

The semiconductor layer 15 overlaps the gate electrode 13 with a gate insulating layer 14 disposed therebetween. The semiconductor layer 15 may comprise polysilicon or amorphous silicon. The semiconductor layer 15 forms a channel while the scan signal is applied to the gate electrode 13 to transmit the pixel signal of the source electrode 17 to the drain electrode 18.

The ohmic contact layer 16 is formed on the semiconductor layer 15. The ohmic contact layer 16 may comprise impurity-doped polysilicon or amorphous silicon. The ohmic contact layer 16 provides ohmic contact between the semiconductor layer 15 and the source electrode 17 or between the semiconductor layer 15 and the drain electrode 18 to improve the characteristics of the thin film transistor T.

Referring to FIGS. 1 and 2, one end of the source electrode 17 is connected to the data line 12, and the other end of the source electrode 17 overlaps a portion of the semiconductor layer 15. One end of the drain electrode 18 is connected to the pixel electrode 20, and the other end of the drain electrode 18 overlaps a portion of the semiconductor layer 15.

The pixel electrode 20 is connected to the drain electrode 18 through a contact hole C to receive the pixel signal from the drain electrode 18. The pixel electrode 20 may comprise a transparent conductive layer transmitting light supplied form a backlight unit. The pixel electrode 20 may comprise indium tin oxide (ITO), indium zinc oxide (IZO), or indium tin zinc oxide (ITZO).

The pixel electrode 20 includes a plurality of first rod-shaped electrodes 20a arranged in parallel and spaced apart from one another at substantially regular intervals. An arrangement interval L2 can be more than twice a width L1 of the first rod-shaped electrode 20a. The first rod-shaped electrode 20a having the width L1 smaller than the arrangement interval L2 generates fringe fields inclined to both sides thereof together with second rod-shaped electrodes 28a. The liquid crystal molecules are aligned horizontally to the fringe fields, thus improving side visibility.

The first rod-shaped electrodes 20a may be inclined with respect to the gate line 11. That is, the first rod-shaped electrodes 20a are not parallel to the gate line 11 but inclined at a predetermined angle with respect to the gate line 11. The first rod-shaped electrodes 20a may be arranged symmetrically with respect to a virtual line dividing the center of one pixel area. The rod-shaped electrodes inclined at different angles in one pixel area form multi-domains, and thereby it is possible to improve side visibility.

A central portion 20b, which is a symmetrical center, is arranged substantially in the center of the pixel electrode 20. End terminals of the first rod-shaped electrodes 20a and the central portion 20b are connected to each other by a connection portion 20c. Accordingly, a pixel voltage transmitted by the drain electrode 18 is charged commonly to the plurality of first rod-shaped electrodes 20a. Thus, the plurality of first rod-shaped electrodes 20a have the same pixel voltage.

An alignment layer is formed on the uppermost surface of the lower substrate 1 where the pixel electrode 20 is formed. In an exemplary embodiment, a horizontal alignment layer is formed on the lower substrate 1. The rubbing direction of the alignment layer is parallel to a long or short side of the lower substrate 1. Accordingly, the respective first rod-shaped electrodes 20a of the pixel electrode 20, inclined with respect to the long or short side of the lower substrate 1, form a predetermined angle with respect to the alignment direction of the alignment layer. In an exemplary embodiment, the first rod-shaped electrodes 20a form an angle of about 10° to about 30° with respect to the alignment direction of the alignment layer. For example, the angle can be about 20°.

The storage pattern 19 includes a storage central line 19b and a storage connection line 19a. The storage central line 19b is arranged substantially at the center of the pixel area. The storage connection line 19a is parallel with the data line 12 and the first connection portion 20c of the pixel electrode 20. The storage connection line 19a and the first connection portion 20c overlap each other with a passivation layer 21 interposed therebetween, thereby forming a storage capacitor.

The upper substrate 2 includes a black matrix 25, a color filter 26, an overcoat layer 27, and the common electrode 28. The black matrix 25 comprises an opaque layer through which light does not pass. The color filter 26 is arranged in an area defined by the black matrix 25. Adjacent color filters 26 are arranged to have colors different from each other. The color filter 26 may be formed on the lower substrate 1 together with the thin film transistor T, which is referred to as a color filter on array (COA) structure.

The overcoat layer 27 is formed on the black matrix 25 and the color filter 26 to planarize the surface of the upper substrate 2. The overcoat layer 27 may comprise an organic material.

The common electrode 28 is formed on upper surface of the overcoat layer 27. The common electrode 28 is applied with a common voltage, i.e., a reference voltage for driving the liquid crystal 30. The common electrode 28 may comprise a transparent conductive layer transmitting light.

The common electrode 28 includes a plurality of second rod-shaped electrodes 28a arranged in parallel and spaced apart from one another at substantially regular intervals. The arrangement interval of the second rod-shaped electrodes 28a may be the same as that of the first rod-shaped electrodes 20a. Referring to FIG. 1, the second rod-shaped electrodes 28a are connected to one another by a second connection portion 28b. Accordingly, the plurality of second rod-shaped electrodes 28a is supplied with the same common voltage.

Referring to FIGS. 1 and 2, the second rod-shaped electrodes 28a are arranged alternately with the first rod-shaped electrodes 20a. That is, one second rod-shaped electrode 28a is arranged between two adjacent first rod-shaped electrodes 20a. The first and second rod-shaped electrodes 20a and 28a are arranged in an inclined direction.

Referring to FIG. 3, fringe fields are generated by the first and second rod-shaped electrodes 20a and 28a arranged in an inclined direction and thereby the liquid crystal molecules are rotated along the electric field direction.

An alignment layer is formed on the uppermost surface of the upper substrate 2 where the common electrode 28 is formed. The alignment layer is a horizontal alignment layer the same as the above-described alignment layer of the lower substrate 1. Since the alignment layer formed on the upper substrate 2 is rubbed parallel to that of the lower substrate 1, the rubbing direction of the alignment layer formed on the upper substrate 2 forms an angle of about 10° to about 30° inclined with respect to the second rod-shaped electrode 28a.

With the horizontal alignment layers formed on the upper and lower substrates 2 and 1, the liquid crystal molecules disposed in the LCD device in accordance with an exemplary embodiment of the present invention maintains the horizontally aligned state during a power-off state. When a voltage is applied to the pixel electrode 20 and the common electrode 28, the liquid crystal molecules are rotated along the direction of the electric field generated thereby.

Since the pixel electrode 20 and the common electrode 28 have a substantially small width, a desired electric field may not be generated when misalignment occurs in a process of bonding the upper and lower substrates 2 and 1. Accordingly, it is difficult to accurately control the liquid crystal and thus the light transmittance is decreased.

Referring to Graph 1, variations in transmittance according to the size of misalignment were measured by changing the width of the first and second rod-shaped electrodes 20a and 28a.

According to Graph 1, the transmittance reduces as the size of misalignment increases. The decrease in transmittance is reduced as the width (w) of the rod-shaped electrodes is increased from about 4 μm to about 8 μm. Accordingly, the effect of the misalignment on transmittance decreases as the width of the rod-shaped electrode increases.

However, when the width of the rod-shaped electrodes is increased too much, the amount of liquid crystal molecules to be controlled is increased. This may cause the transmittance to decrease and the driving voltage to increase. Accordingly, the rod-shaped electrodes have a maximum width within a predetermined range.

Referring to Graph 2, variations in transmittance according to the size of misalignment are measured by changing the arrangement interval of the rod-shaped electrodes.

According to Graph 2, the transmittance is reduced as the arrangement interval (I) of the rod-shaped electrodes is increased from about 9.5 μm to about 13.5 μm. Accordingly, the effect of the misalignment on transmittance decreases as the arrangement interval of the rod-shaped electrodes increases.

However, when the arrangement interval of the rod-shaped electrodes is increased too much, the number of rod-shaped electrodes arranged in one pixel is reduced, thus causing the side visibility not to be improved and the driving voltage to be increased. Accordingly, the rod-shaped electrodes are arranged at a maximum interval within a predetermined range.

In an exemplary embodiment of the present invention, each of the first and second rod-shaped electrodes 20a and 28a has the same width, e.g., about 4 μm to about 6 μm. For example, the width can be about 5 μm. The arrangement interval of the rod-shaped electrodes is about 11.5 μm to about 13.5 μm. For example, the arrangement interval can be about 12.5 μm.

In an exemplary embodiment of the present invention, the first and second rod-shaped electrodes 20a and 28a have widths different from each other. For example, the width of the first rod-shaped electrode 20a is about 4 μm to about 6 μm, and that of the second rod-shaped electrode 28a is about 4 μm. The width of the first rod-shaped electrode 20a may be about 6 μm. For example, the width of the second rod-shaped electrode 28a may be about 4 μm to about 6 μm, and that of the first rod-shaped electrode 20a may be about 4 μm.

The arrangement interval of the rod-shaped electrodes can be about 11.5 μm to about 13.5 μm. For example, the arrangement interval is about 12.5 μm.

Referring to Graph 3, variations in transmittance according to the size of misalignment were measured with respect to the arrangement intervals of the rod-shaped electrodes of the above-proposed examples and a conventional structure.

According to Graph 3, the rod-shaped electrodes of the examples are less affected by the misalignment, compared with the conventional structure. For example, the transmittance of the examples is increased by about 10% compared with the conventional structure, when the size of misalignment is about 6 μm.

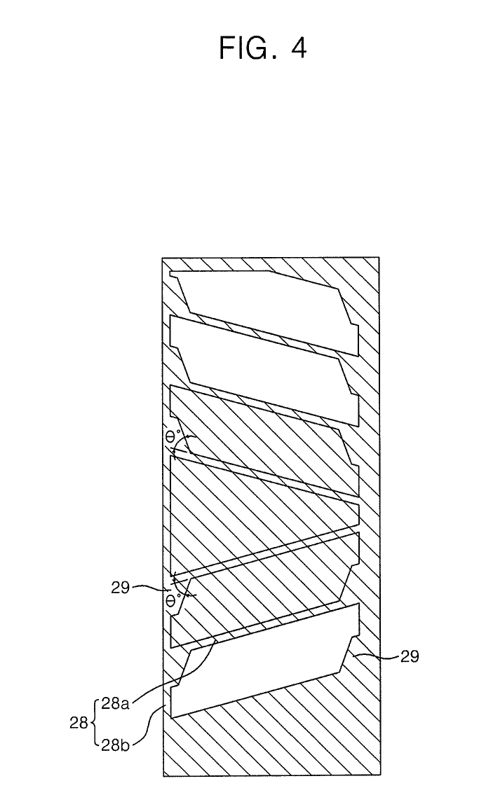

A texture prevention portion may be included in the common electrode 28 or the pixel electrode 20 in accordance with an exemplary embodiment of the present embodiment. FIG. 4 is a plan view showing a texture prevention portion 29 in accordance with an exemplary embodiment of the present invention.

The pixel electrode 20 includes the first rod-shaped electrodes 20a and a first connection portion 20c connecting the first rod-shaped electrodes 20a. The first rod-shaped electrodes 20a and the first connection portion 20c are connected to each other to form a rectangular shape. Texture is generated by the distortion of the electric field at an edge corner portion of the rectangle. The texture prevention portion 29 can be formed at an edge of either the pixel electrode 20 or the common electrode 28. Although FIG. 4 shows the texture prevention portion 29 formed in the common electrode 28, the texture prevention portion 29 may be formed in the pixel electrode 20. The texture prevention portion 29 prevents generation of texture by an asymmetrical structure of the pixel electrode 20 and the common electrode 28.

The texture prevention portion 29 may be formed in both the pixel electrode 20 and the common electrode 28. When the texture prevention portion 29 is formed in the pixel electrode 20, the texture prevention portion 29 may not be formed in the common electrode 28, and vice versa, to prevent the generation of texture and a decrease in aperture ratio.

For example, as shown in FIG. 4, the texture prevention portion 29 is formed at an edge of the rectangular defined by the second rod-shaped electrodes 28a and the second connection portion 28b of the common electrode 28. The texture prevention portion 29 is inclined at a predetermined angle with respect to the second rod-shaped electrode 28a. Accordingly, a part of the corner portion of a penetration hole having a rectangular shape formed in the common electrode 28 is hidden by the texture prevention portion 29.

For example, the angle θ defined by the texture prevention portion 29 with respect to the second rod-shaped electrode 28a may be varied within the range of about 20° to about 60°. For example, the angle θ for preventing the generation of texture and the decrease in aperture ratio can be about 30°.

The texture prevention portion 29 may be formed at two edges facing each other, among the four edges of the rectangle defined by the second rod-shaped electrodes 28a and the second connection portion 28b.

The aforementioned texture defect by the distortion of the electric field may be prevented by removing a part of the first connection portion 20c of the pixel electrode 20 or by removing a part of the second connection portion 28b of the common electrode 28. In the pixel electrode 20 according to an exemplary embodiment of the present invention, the first connection portion 20c connecting the end terminals of the first rod-shaped electrodes 20a is formed on both ends of the first rod-shaped electrodes 20a. In the common electrode 28 according to an exemplary embodiment of the present invention, the second connection portion 28b connecting the second rod-shaped electrodes 28a is formed on both ends of the second rod-shaped electrodes 28a. Accordingly, the texture defect may be reduced by removing a part of the first connection portion 20c or removing a part of the second connection portion 28b existing at one ends of the rod-shaped electrodes, leaving a part existing at the other end thereof.

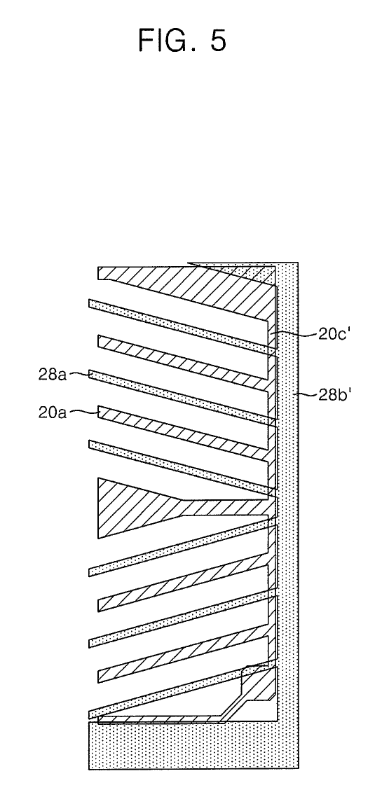

Referring to FIG. 5, a modified first connection portion 20c′ may connect only one end of the first rod-shaped electrode 20a and not to connect the other end thereof. A modified second connection portion 28b′ may connect only one end of the second rod-shaped electrode 28a and not to connect the other end thereof. Referring to FIG. 5, the modified first and second connection portion 20c′ and 28b′ are formed on only one side of the rod-shaped electrodes. Alternatively, one of the modified first and second connection portion 20c′ and 28b′ may be formed on both sides of the rod-shaped electrodes, and the other modified first and second connection portion 20c′ and 28b′ may be formed on only one side of the rod-shaped electrodes.

Referring to FIG. 5, the directions of the first rod-shaped electrodes 20a and the second rod-shaped electrodes 29a, which are not connected by the modified first and second connection portion 20c′ and 28b′, are the same. Alternatively, the directions may be opposite to each other.

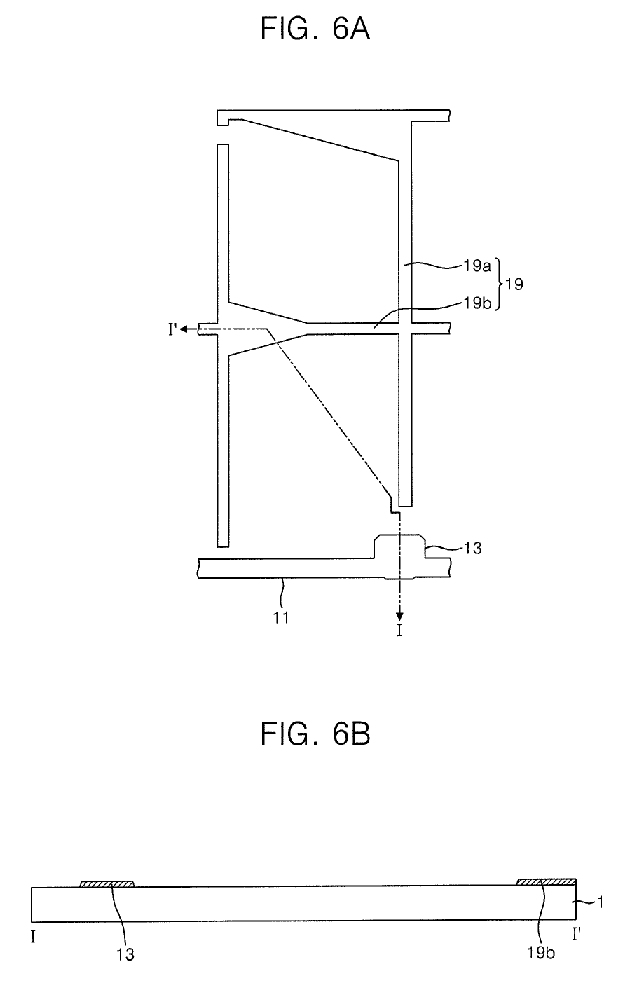

A method of manufacturing an LCD device in accordance with an exemplary embodiment of the present invention is described with reference to FIGS. 6 to 10.

FIGS. 6A and 6B are a plan view and a cross-sectional view, respectively, illustrating a method of manufacturing an LCD device using a first mask process in accordance with an exemplary embodiment of the present invention.

Agate metal pattern including the gate line 11, the gate electrode 13, the storage connection line 19a, and the storage central line 19b is formed on the lower substrate 1 by a first mask process.

A gate metal layer is formed on the lower substrate 1 by a deposition process such as, for example, sputtering. The gate metal layer may comprise metal including molybdenum (Mo), titanium (Ti), copper (Cu), aluminum-neodymium (AlNd), aluminum (Al), chromium (Cr), Mo alloy, Cu alloy, or Al alloy in a single layer or in a multi-layer thereof. The gate metal layer is patterned by photolithography and etching processes using a first mask, thus forming the gate metal pattern including the gate line 11, the gate electrode 13, the storage connection line 19a, and the storage central line 19b.

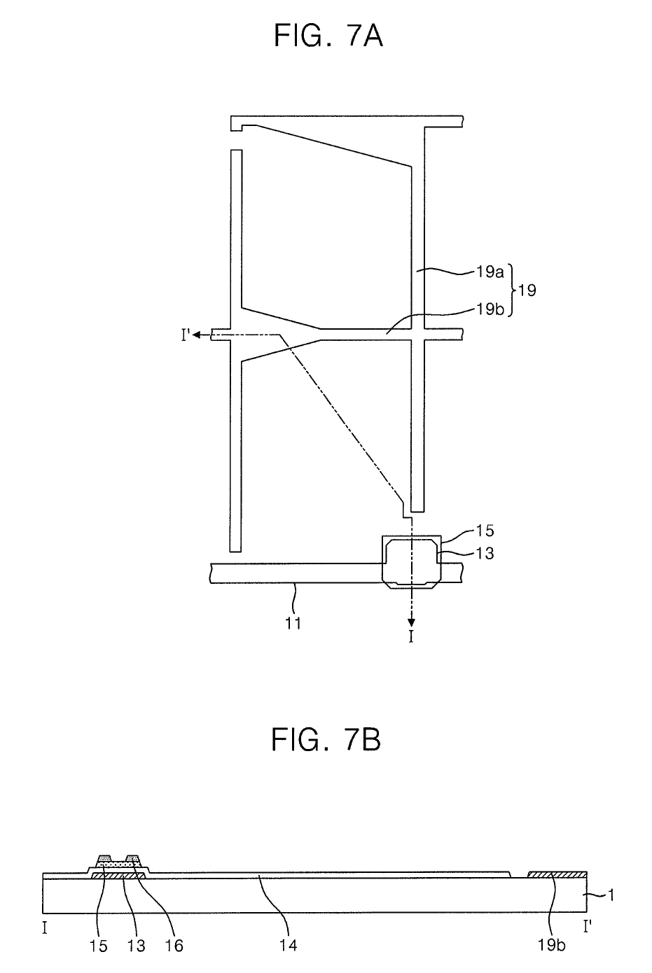

FIGS. 7A and 7B are a plan view and a cross-sectional view, respectively, illustrating a method of manufacturing an LCD device using a second mask process in accordance with an exemplary embodiment of the present invention.

A gate insulating layer 14 is formed on the lower substrate 1 where the gate metal pattern is formed and then a semiconductor pattern is formed thereon by a second mask process. The gate insulating layer 14, an amorphous silicon layer, and an impurity (n⁺ or p⁺) doped amorphous silicon layer are sequentially formed on the lower substrate 1 where the gate metal pattern is formed. For example, the gate insulating layer 14, the amorphous silicon layer, and the impurity doped amorphous silicon layer are formed by a deposition method such as, for example, plasma-enhanced chemical vapor deposition (PECVD). The gate insulating layer 14 comprises an inorganic insulating material such as silicon oxide (SiOx) or silicon nitride (SiNx). The amorphous silicon layer and the impurity-doped amorphous silicon layer are patterned by photolithography and etching processes using a second mask, thus forming a semiconductor layer 15 and an ohmic contact layer 16.

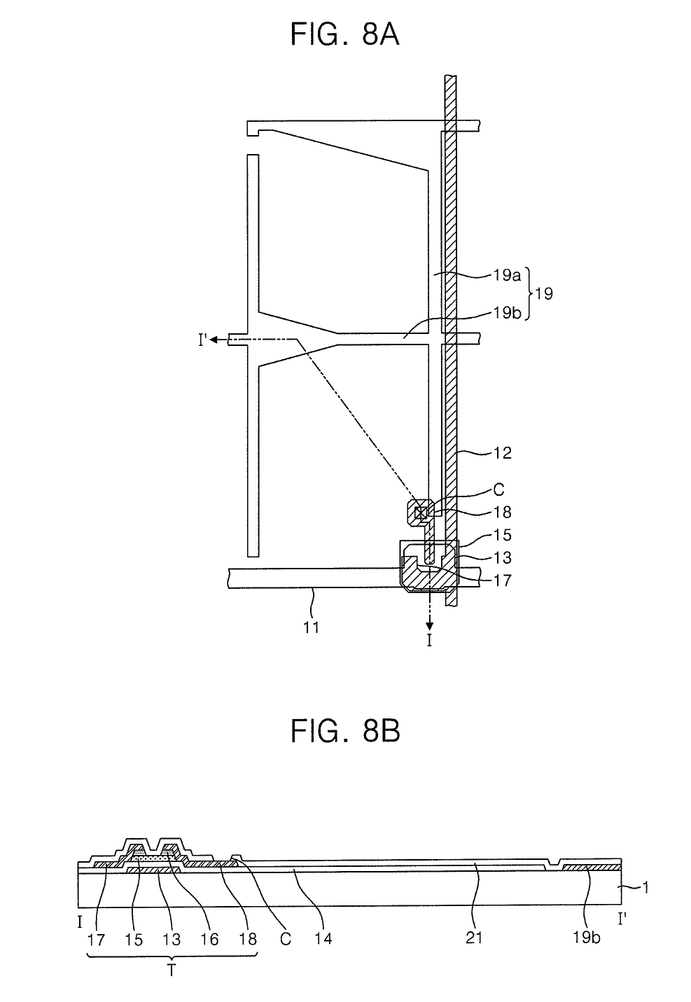

FIGS. 8A and 8B are a plan view and a cross-sectional view, respectively, illustrating a method of manufacturing an LCD device using third and fourth mask processes in accordance with an exemplary embodiment of the present invention.

A data metal pattern including a data line 12, a source electrode 17 and a drain electrode 18 is formed on the lower substrate 1 where the semiconductor layer 15 and the ohmic contact layer 16 are formed. A data metal layer is formed on the lower substrate 1, where the semiconductor layer 15 and the ohmic contact layer 16 are formed, by a deposition method such as, for example, sputtering. The data metal layer comprises metal including molybdenum (Mo), titanium (Ti), copper (Cu), aluminum-neodymium (AINd), aluminum (Al), chromium (Cr), Mo alloy, Cu alloy, or Al alloy in a single layer or in a multi-layer thereof. After a photoresist is coated on the data metal layer, the data metal layer is patterned by photolithography and etching processes using a third mask. Thus the data metal pattern including the data line 12, the source electrode 17 and the drain electrode 18 can be formed.

A passivation layer 21 including a contact hole C is formed by a fourth mask process. The passivation layer 21 is formed on the gate insulating layer 14, where the data metal pattern is formed, by a deposition method such as, for example, PECVD, spin coating, or spinless coating. The passivation layer 21 comprises a same inorganic insulating material as the gate insulating layer 14 formed by a deposition method such as, for example, CVD or PECVD. The passivation layer may comprise an organic insulating material such as an acrylic organic compound, BCB or PFCB formed by a deposition method such as, for example, spin coating or spinless coating. The passivation layer 21 may be formed in a dual-layered structure of an inorganic insulating material and an organic insulating material. After a photoresist is coated on the passivation layer, the photoresist is exposed and developed by photolithography and etching processes using a fourth mask. Thus a photoresist pattern in a region where the passivation layer 21 is to be formed can be formed.

Then, the passivation layer 21 is patterned by an etching process using the photoresist pattern. Thus the contact hole C can be formed.

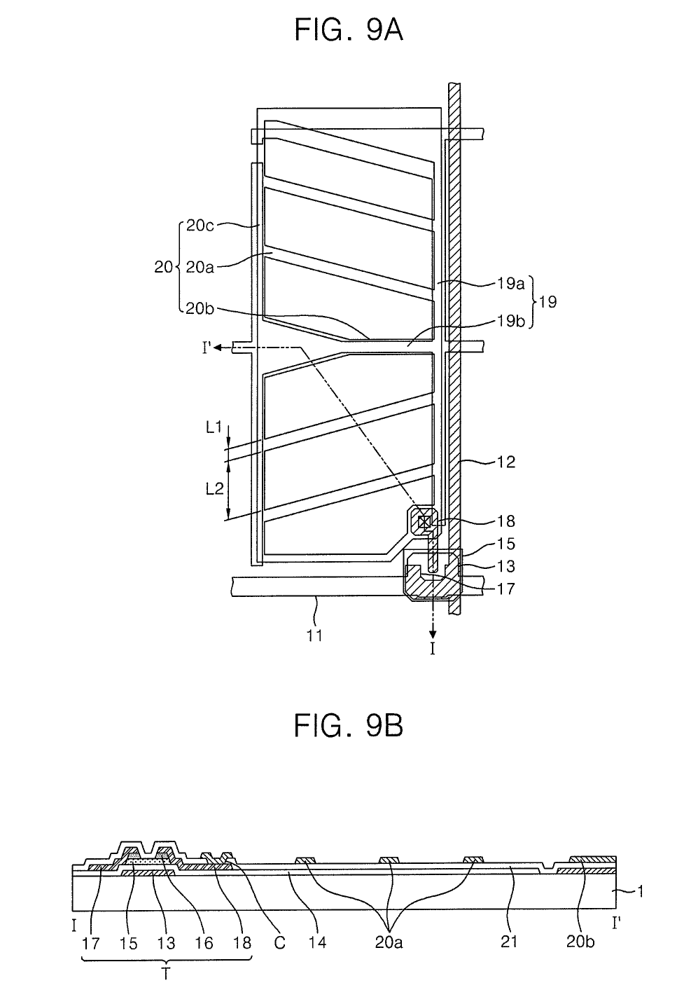

FIGS. 9A and 9B are a plan view and a cross-sectional view, respectively, illustrating a method of manufacturing an LCD device using a fifth mask process in accordance with an exemplary embodiment of the present invention.

A pixel electrode 20 is formed on the passivation layer 21 by a fifth mask process. A transparent conductive layer is formed on the whole surface of the passivation layer 21 having the contact hole C by a deposition method such as, for example, sputtering. The transparent conductive layer comprises indium tin oxide (ITO), tin oxide (TO), indium zinc oxide (IZO), tin dioxide (SnO₂), or amorphous- indium tin oxide (a-ITO).

The transparent conductive layer is patterned by photolithography and etching processes using a fifth mask, thus forming the pixel electrode 20. The pixel electrode 20 is connected to the drain electrode 18 through the contact hole C.

In an exemplary embodiment of the present invention, the fifth mask for forming the pixel electrode 20 is formed such that the pixel electrode 20 may have a plurality of first rod-shaped electrode 20a spaced apart from one another at regular intervals. For example, the fifth mask is formed such that the width of the first rod-shaped electrode 20a is about 5 μm and the arrangement interval of the first rod-shaped electrodes 20a is about 12.5 μm. Then, a pixel electrode pattern for minimizing the decrease in transmittance by the misalignment is formed by photolithography and etching processes using the fifth mask. In the fifth mask process in accordance with an exemplary embodiment of the present invention, only the shape of the mask is modified to manufacture an LCD device which is less affected by the misalignment.

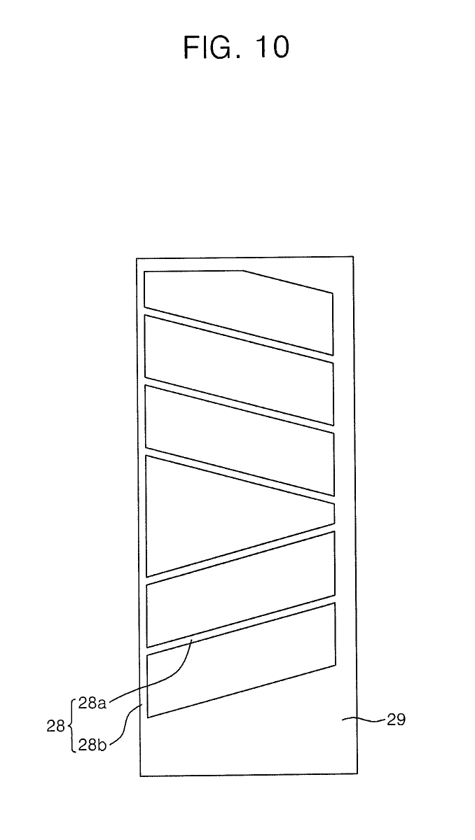

FIG. 10 is a plan view showing a shape of a common electrode in an LCD device in accordance with an exemplary embodiment of the present invention.

Referring to FIG. 10, a common electrode 28 has a plurality of second rod-shaped electrodes 28a spaced apart from one another at regular intervals. Each of the second rod-shaped electrodes 28a is formed between adjacent two first rod-shaped electrodes 20a. The texture prevention portion 29 is formed in the common electrode 28. The texture prevention portion 29 extends from the lowermost one of the plurality of second rod-shaped electrodes 28a.

After an alignment layer is coated and rubbed on the upper and lower substrates 2 and 1, the upper and lower substrates 2 and 1 are bonded to each other with the liquid crystal disposed therebetween.

According to an exemplary embodiment of the present invention, it is possible to minimize the decrease in light transmittance due to the misalignment and prevent the increase in driving voltage by expanding the width of the rod-shaped electrodes and the arrangement interval of the rod-shaped electrodes.

With the texture prevention portion formed in the common electrode, it is possible to prevent light leakage due to the misalignment by shielding a horizontal electric field generated by the gate line.

Although the illustrative embodiments of the present invention have been described herein with reference to the accompanying drawings, it is to be understood that the present invention should not be limited to those precise embodiments and that various other changes and modifications may be affected therein by one of ordinary skill in the related art without departing from the scope or spirit of the invention. All such changes and modifications are intended to be included within the scope of the invention as defined by the appended claims.

What is claimed is:

1. A liquid crystal display (LCD) device comprising:
a lower substrate including a gate line, a data line, and a thin film transistor;
a pixel electrode formed on the lower substrate and including a plurality of first rod-shaped electrodes spaced apart from one another at substantially regular intervals;
an upper substrate disposed opposite the lower substrate;
a common electrode formed on the upper substrate and including a plurality of second rod-shaped electrodes arranged alternately with the first rod-shaped electrodes at substantially same intervals as the first rod-shaped electrodes; and
a liquid crystal disposed between the lower substrate and the upper substrate,
wherein a width of each of the first and second rod-shaped electrodes is about 4 μm to about 6 μm and the arrangement interval thereof is about 11.5 μm to about 13.5 μm.

2. A liquid crystal display (LCD) device comprising:
a lower substrate including a gate line, a data line, and a thin film transistor;
a pixel electrode formed on the lower substrate, the pixel electrode including a plurality of first rod-shaped electrodes spaced apart from one another at substantially regular intervals and a first connection portion connecting end terminals of the plurality of first rod-shaped electrodes with one another;
an upper substrate disposed opposite the lower substrate;
a common electrode formed on the upper substrate, the common electrode including a plurality of second rod-shaped electrodes arranged alternately with the first rod-shaped electrodes and a second connection portion connecting end terminals of the plurality of second rod-shaped electrodes with one another;
a liquid crystal disposed between the lower substrate and the upper substrate; and
a texture prevention portion formed at a first area where a first rod-shaped electrode is connected to the first connection portion or a second area where a second rod-shaped electrode is connected to the second connection portion, wherein the texture prevention portion is inclined with respect to the first rod-shaped electrode or the second rod-shaped electrode.

3. The LCD device of claim 2, wherein the texture prevention portion forms an angle of about 20° to about 60° with respect to the first rod-shaped electrode or the second rod-shaped electrode.

4. The LCD device of claim 3, wherein the texture prevention portion forms an angle of about 30° with respect to the first rod-shaped electrode or the second rod-shaped electrode.

5. The LCD device of claim 2, wherein the texture prevention portion is formed at two edges facing each other, respectively, in a rectangle defined by the first rod-shaped electrode and the first connection portion or defined by the second rod-shaped electrode and the second connection portion.

6. The LCD device of claim 2, wherein the first connection portion connects one end of the first rod-shaped electrodes with each other formed in a direction, and the second connection portion connects one end of the second rod-shaped electrodes with each other formed in the opposite direction to that of the first rod-shaped electrodes.

7. The LCD device of claim 2, wherein the first connection portion connects one end of the first rod-shaped electrodes with each other formed in a direction, and the second connection portion connects one end of the second rod-shaped electrodes with each other formed in the same direction as that of the first rod-shaped electrodes.

8. A liquid crystal display (LCD) device comprising:
a lower substrate including a gate line, a data line, and a thin film transistor;
a pixel electrode formed on the lower substrate, the pixel electrode including a plurality of first rod-shaped electrodes spaced apart from one another at substantially regular intervals and a first connection portion connecting one end of the plurality of first rod-shaped electrodes with one another;
an upper substrate disposed opposite the lower substrate;
a common electrode formed on the upper substrate and including a plurality of second rod-shaped electrodes arranged alternately with the first rod-shaped electrodes and a second connection portion connecting one end of the plurality of second rod-shaped electrodes with each other; and
a liquid crystal disposed between the lower substrate and the upper substrate.

9. The LCD device of claim 8, wherein the first connection portion connects one end of the first rod-shaped electrodes with each other formed in a direction, and the second connection portion connects one end of the second rod-shaped electrodes with each other formed in the opposite direction to that of the first rod-shaped electrodes.

10. The LCD device of claim 8, wherein the first connection portion connects one end of the first rod-shaped electrodes with each other formed in a direction, and the second connection portion connects one end of the second rod-shaped electrodes with each other formed in the same direction as that of the first rod-shaped electrodes.
